(19) United States
(12) Patent Application Publication
(10) Pub. No.: US 2015/0204560 A1
(43) Pub. Date: Jul. 23, 2015

(54) ENVIRONMENTAL PARAMETER SETTING AIDING DEVICE AND METHOD

(71) Applicant: Azbil Corporation, Tokyo (JP)

(72) Inventors: Tetsuya TAKAHASHI, Tokyo (JP); Takashi KOYANAGI, Tokyo (JP); Akihiro SUZUYAMA, Tokyo (JP)

(73) Assignee: AZBIL CORPORATION, Tokyo (JP)

(21) Appl. No.: 14/600,127

(22) Filed: Jan. 20, 2015

(30) Foreign Application Priority Data
Jan. 22, 2014 (JP) 2014-009156

(51) Int. Cl. F24F 11/00; G05B 15/02; F24F 3/00

(52) U.S. Cl. CPC F24F 11/006; F24F 11/001; F24F 11/0076; F24F 3/00; F24F 11/0086; G05B 15/02; F24F 2011/0047; F24F 2011/0057; F24F 2011/0063; F24F 2011/0067; F24F 2011/0075; F24F 2011/0091; F24F 2011/0061

(57) ABSTRACT

An environmental parameter setting aiding device includes: a data acquiring system that acquires, and saves as environmental parameter information, a current parameter value of an environmental parameter of an air conditioning controlling system, and acquires, and saves as complaint information, complaints from various occupants indicating perceptions that a temperature environment, using the parameter value, is too hot or too cold; a complaint proportion calculating portion that calculates, from the complaint information that has been stored, a complaint proportion, indicating a proportion of perceptions of being too hot or too cold, for each individual parameter value; a parameter value selecting portion that selects, as a recommended parameter value, the parameter value wherein the complaint proportion is nearest to 50%; and an aid screen displaying portion that presents the recommended value in an aid screen.

### CROSS REFERENCE TO RELATED APPLICATION

This application claims priority under 35 U.S.C. §119 to Japanese Patent Application No. 2014-009156, filed on Jan. 22, 2014, the entire content of which being hereby incorporated herein by reference.

### FIELD OF TECHNOLOGY

The present invention relates to an air-conditioning controlling technology, and, in particular, relates to an environmental parameter setting aiding technology for setting values for environmental parameters that are target values for an air-conditioning system in response to complaints, from building occupants, of perceptions of being too cold or too hot.

### BACKGROUND

One responsibility of equipment operators for buildings or facilities is to provide occupants with appropriate temperature environments. On the other hand, the occupants may feel that the current temperature environment is uncomfortable, or make a request to the equipment operator to improve the environment, that is, may make a complaint about feeling too cold or too hot.

Typically the equipment operator adjusts an environmental parameter, such as a temperature setting for the room, as means by which to achieve a comfortable temperature environment.

At this time, the sensitivities of the occupants in relation to the temperature environments are not always the same, where, even given an identical temperature, there will be some occupants who feel too hot and some occupants who feel comfortable, so how much to adjust the temperature setting relies greatly on the experience of the equipment operator. When the equipment operator receives a complaint from an occupant regarding feeling too hot or feeling too cold, the equipment operator responds by changing the applicable temperature setting based on the experience of the equipment operator.

When the equipment operator receives a complaint from an occupant regarding a perceived temperature, for example, a complaint of “too hot,” the equipment operator may respond by changing the setting for an environmental parameter, such as reducing the temperature setting for the applicable room. However, in some cases the priority will be on eliminating the complaint, causing the change in the setting to the too much, producing a risk that this may produce the opposite complaint of “too cold” from another occupant. In this case, there are also times where this produces a risk that this will consume more energy in air-conditioning than is necessary. In particular, typically, when a tenant manager, or the like, makes changes to settings after receiving complaints from users, this tenant manager has less experience than an equipment operator, so such a risk is more likely to result.

Furthermore, a technology has been proposed for adjusting a reference value depending on the degree to which an energy conservation target is achieved, in addition to changing settings for environmental parameters so as to comply with complaints, in response to the result of comparing reference values with complaint proportions from occupants. See, for example, Japanese Patent No. 4899979.

However, given this technology no change is made in an environmental parameter until a ratio of the complaints received from the occupants that either increases or decreases energy consumption exceeds a reference value, to require a contribution to energy savings from the occupants, and thus there is a problem in that it is not possible to respond with flexibility to requests from the occupants.

The present invention is to solve issues such as set forth above, and an aspect thereof is to provide an environmental parameter setting aiding technology for aiding in selecting and setting environmental parameters so as to be able to handle flexibly complaints from occupants while suppressing risk that results from changing parameter values.

### SUMMARY

In order to achieve such an aspect as described above, an environmental parameter setting aiding device according to the present invention aids the setting of an environmental parameter that is a target value for an air-conditioning controlling system, based on a complaint from an occupant. The environmental parameter setting aiding device includes: a data acquiring system that acquires, and saves as environmental parameter information, a current parameter value of an environmental parameter of the air conditioning controlling system, and acquires, and saves as complaint information, complaints from various occupants indicating perceptions that the temperature environment, using the parameter value, is too hot or too cold; a complaint proportion calculating portion that calculates, from the complaint information that has been stored, a complaint proportion, indicating the proportion of perceptions of being too hot or too cold, for each individual parameter value; a parameter value selecting portion that selects, as a recommended parameter value, the parameter value wherein the complaint proportion is nearest to 50%; and an aid screen displaying portion that presents the recommended value in an aid screen.

Moreover, in one example configuration of an environmental parameter setting aiding device, as set forth above, according to the present invention, the complaint proportion calculating portion estimates a complaint proportion for a parameter value wherein there is insufficient complaint information, based on a complaint proportion for a parameter value wherein there is complaint information for the parameter value.

Moreover, in one example configuration of an environmental parameter setting aiding device, as set forth above, according to the present invention, the parameter value selecting portion selects, from among the parameter values, a “comfort value,” which is the parameter value that has the complaint proportion that is nearest to 50%, and selects, from among parameter values wherein the complaint proportion is within the tolerance range that has been set in advance, an “energy-saving value,” which is the parameter value that saves the most energy; and

Moreover, in one example configuration of an environmental parameter setting aiding device, as set forth above, according to the present invention, an environmental parameter setting portion acquires a value that is determined by an operating input by the aid screen, and sets, as a new target value for the air-conditioning controlling system, an environmental parameter that is the determined value.

Furthermore, an environmental parameter setting aiding method according to the present invention is used in an environmental parameter setting aiding device for aiding the setting of an environmental parameter that is a target value for an air-conditioning controlling system, based on a complaint from an occupant. The method includes: a data acquiring step wherein a data acquiring system acquires, and saves as environmental parameter information, a current parameter value of an environmental parameter of the air conditioning controlling system, and acquires, and saves as complaint information, complaints from various occupants indicating perceptions that the temperature environment, using the parameter value, is too hot or too cold; a complaint proportion calculating step wherein a complaint proportion calculating portion calculates, from the complaint information that has been stored, a complaint proportion, indicating the proportion of perceptions of being too hot or too cold, for each individual parameter value; a parameter value selecting step wherein a parameter value selecting portion selects, as a recommended parameter value, the parameter value wherein the complaint proportion is nearest to 50%; and an aid screen displaying step wherein an aid screen displaying portion presents the recommended value in an aid screen.

The present invention, through the aid screen, makes it possible to provide, to the equipment operator, the temperature that is the recommended value, that is, the temperature setting that will achieve the greatest balance for the occupants as a whole. Consequently, this enables aid in selecting and setting an environmental parameter value, by the equipment operator, so as to not only reduce the risk that occurs when changing a parameter value, but also enables flexible handling of complaints by occupants that they feel too cold or too hot.

### BRIEF DESCRIPTIONS OF THE DRAWINGS

FIG. 1 is a block diagram illustrating a structure for an environmental parameter setting aiding device according to Example.

FIG. 2 is a flowchart illustrating an environmental parameter setting aiding procedure according to the Example.

FIG. 3 is an example display for an aid screen according to the Example.

FIG. 4 is a flowchart illustrating an environmental parameter setting aiding procedure according to Another Example.

FIG. 5 is an example display for an aid screen according to the Another Example.

FIG. 6 is a block diagram illustrating a structure for an environmental parameter setting aiding device according to Yet Another Example.

FIG. 7 is a flowchart illustrating an environmental parameter setting aiding procedure according to the Yet Another Example.

FIG. 8 is an example display for an aid screen according to the Yet Another Example.

### DETAILED DESCRIPTION

The principle behind the present disclosure will be explained first.

In an air-conditioning controlling system that is provided in a building or in equipment in a building, it is necessary to adjust values for environmental parameters so as to produce a temperature environment that is tolerable for more of the occupants when, in response to the complaint from an occupant regarding feeling too hot or too cold, a value of an environmental parameter is adjusted to a target value for air-conditioning control, such as with a predicted mean vote (PMV) for a temperature setting or a humidity setting.

Typically, the proportion of complaints from occupants changes in response to the environmental parameter that has been set. For example, in the case of adjusting a temperature setting, if the temperature setting is low, than the lower the setting, the greater the proportion of complaints of “too cold,” and if the temperature setting is high, the greater the proportion of complaints of “too hot.” At this time, there is a tendency for both the ratio of “too cold” complaints and the ratio of “too hot” complaints to be low at the temperature setting wherein there is the greatest balance between the “too cold” complaints and the “too hot” complaints from the occupants.

The present invention focuses on this tendency that exists in the complaint proportions, and selects, for a recommended value wherein there is the optimal balance for the occupants overall, the value for the environmental parameter wherein there is the greatest balance in the ratio of the “too cold” complaints and the “too hard” complaints from the occupants, that is, the value for the environmental parameter wherein the complaint proportion is nearest to 50%. Examples based on this principle will be explained in Example and Another Example, described below.

Moreover, the temperature setting wherein there is the greatest balance between the “too cold” complaints and the “too hot” complaints from the occupants is the value for the environmental parameter wherein there is the optimal balance for the occupants as a whole; however, for the equipment operator, who must, to some degree at least, reduce energy consumption, this does not necessarily mean that the most appropriate value has been selected for the environmental parameter.

The present invention focuses on this mutually contradictory nature of the comfort for the occupants and energy conservation, to select, and provided to the equipment operator, a comfort value that is the value of the environmental parameter wherein there is the greatest balance in the ratio of the “too cold” complaints and the “too hot” complaints from the occupants, and the energy-saving value, that is the value for the environmental parameter wherein the energy conservation is the greatest, within the tolerance range, to enable the equipment operator to select an appropriate value for the environmental parameter based on the comfort value and on the energy-saving value. An example based on this principle will be explained in Yet Another Example, described below.

Forms for carrying out the present invention will be explained next in reference to the figures.

### Example

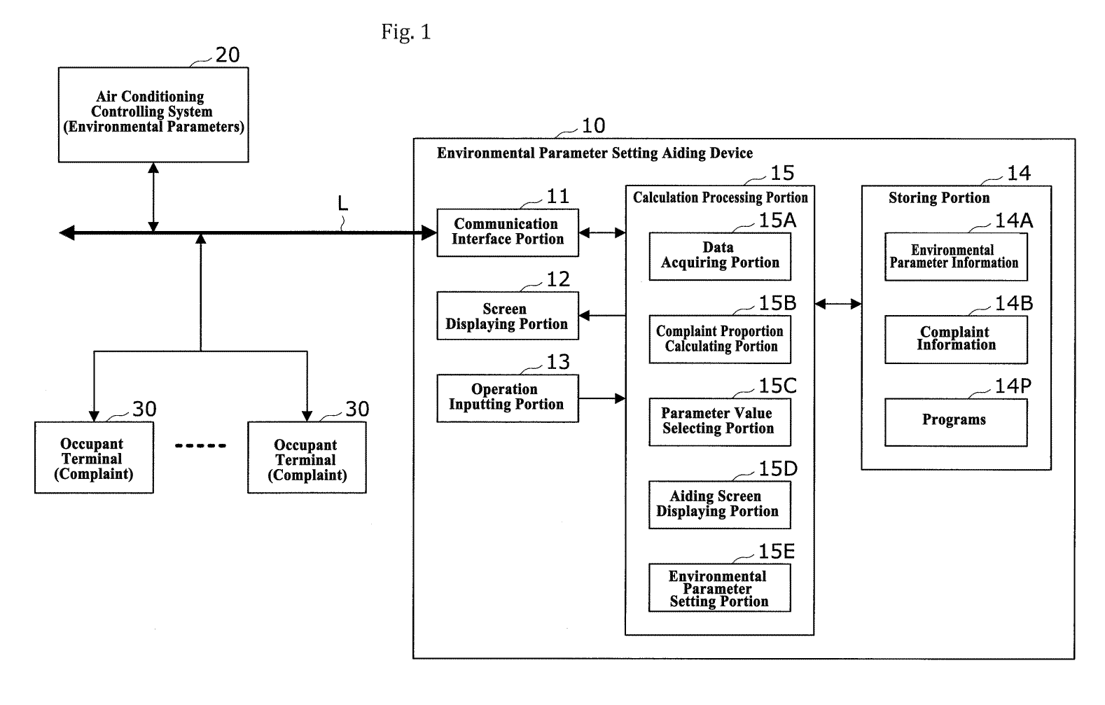

FIG. 1 will be referenced first to explain an environmental parameter setting aiding device 10 according to Example according to the present invention. FIG. 1 is a block diagram illustrating a structure for an environmental parameter setting aiding device according to the Example.

The environmental parameter setting aiding device 10, overall, is structured from an information processing device, such as a server device or a personal computer, and has the function of aiding in setting an environmental parameter that is a target value for an air-conditioning controlling system, based on complaints from occupants.

The air-conditioning controlling system 20 is a typical system for air-conditioning control of the temperature environment of a building or a facility, and is connected through a communication circuit L to the environmental parameter setting aiding device 10, having a function for reporting the current parameter value for the environmental parameter to the environmental parameter setting aiding device 10, and also for setting, as a target value, a new parameter value that is reported by the environmental parameter setting aiding device 10.

As a whole, an occupant terminal 30 is structured from an information processing terminal, such as a personal computer, a smart phone, or the like, and is connected through a communication circuit L to the environmental parameter setting aiding device 10, and has a function for reporting, to the environmental parameter setting aiding device 10 a complaint, inputted by an occupant, indicating that the occupant feels that the current temperature environment is too hot or too cold.

### Environmental Parameter Setting Aiding Device

The environmental parameter setting aiding device 10 according to the present example will be explained in detail next, referencing FIG. 1.

The environmental parameter setting aiding device 10 is provided with a communication interface portion 11, a screen displaying portion 12, an operation inputting portion 13, a storing portion 14, and a calculation processing portion 15, as the primary functional portions thereof.

The communication interface portion 11 is connected to an air-conditioning controlling system 20 through a communication circuit L, and has a function for exchanging the current parameter values for environmental parameters and new parameter values for environmental parameters, and a function for connecting to an occupant terminal 30 through the communication circuit L, to receive complaints, inputted by the occupants, indicating that the occupant feels that the current temperature environment is too hot or too cold.

The screen displaying portion 12 is made from a screen displaying device, such as an LCD, or the like, and has a function for displaying a screen of various types of information, such as an aid screen, as directed by the calculation processing portion 15.

The operation inputting portion 13 is made from an operation inputting device such as a keyboard, mouse, touch panel, or the like, and has a function for detecting, and outputting to the calculation processing portion 15, an operation by the equipment operator.

The storing portion 14 is made from a storing device such as a hard disk, a semiconductor memory, or the like, and has a function for storing various types of process information and programs 14P used in the procedure, in the calculation processing portion 15, for aiding in setting of the environmental parameter.

The program 14P is a program for producing the various types of processing portions for the process for aiding in the setting of the environmental parameter, through reading in and executing, in the calculation processing portion 15, and is read in, and stored in advance in the storing portion 14, from an external device or a recording medium (neither of which are shown) through connecting through the communication interface portion 11.

Environmental parameter information 14A and complaint information 14B are the primary process information that are stored in the storing portion 14.

The environmental parameter information 14A is, for example, parameter values such as the temperature settings, humidity settings, the too hot/too cold votes, and the like, for each of the air-conditioned areas, acquired by the air-conditioning controlling system 20.

The complaint information 14B are complaints indicating that the temperature environment of the air-conditioned environment wherein there is an occupant is too hot or too cold, that is “too hot”/“too cold,” acquired from the individual occupant terminals 30.

The perceptions by the individual occupants that the temperature environment is too hot or too cold are evaluations regarding the temperature environment using the parameter values that have been set as the environmental parameters for the applicable air-conditioned areas, and are dependent on the parameter values that are set at the time of evaluation, and on the time of year. Because of this, for each of the complaints in the complaint information 14B, an air-conditioned area ID that indicates the air-conditioned area wherein the occupant is present, the parameter values for the environmental parameters that are used in the air-conditioning control in that air-conditioned area, and also the date and time at which the complaint information was acquired are stored in relation to each other.

Note that if occupant terminals 30 are not provided for the occupants, complaint information can be generated by the equipment operator receiving complaints from the individual occupants via telephone or email, to be inputted into the environmental parameter setting aiding device 10. At this time, the equipment operator may use that which is viewed in the air-conditioning controlling system for the parameter values for the environmental parameters in the air-conditioned area wherein the occupant was present at the time that the complaint was produced, or may assign a corresponding parameter value on the environmental parameter setting aiding device 10 side based on the date and time at which a complaint, inputted by the equipment operator, is received.

The calculation processing portion 15 has a CPU and peripheral circuitry, and has a function for enabling the various types of processing portions to carry out the environmental parameter setting aiding procedures through reading-out and executing programs 14B that are stored in the storing portion 14P.

A data acquiring portion 15A, a complaint proportion calculating portion 15B, a parameter value selecting portion 15C, and aid screen displaying portion 15D, and an environmental parameter setting portion 15E are the primary processing portions enabled through the calculation processing portion 15.

The data acquiring portion 15A has a function for acquiring parameter values for the current environmental parameters from the air-conditioning controlling system 20 through a communication interface portion 11, and for storing them in the storing portion 14 as the environmental parameter information 14A, and a function for acquiring, from the occupant terminals 30 of the respective occupants, through the communication interface portion 11, complaints indicating perceptions of the temperature environment, using the applicable parameter values, as being too cold or too hot, and for storing these in the storing portion 14 as complaint information. The acquiring and saving of parameter values in claim information may be processed based on acquisition definition information registered in advance in the storing portion 14.

The complaint proportion calculating portion 15B has a function for calculating, from the complaint information 14B that is stored in the storing portion 14, ratios for the perceptions of too hot/too cold for each of the parameter values for the environmental parameters, that is, for calculating complaint proportions for the complaints indicating “too hot”/“too cold.” The complaint proportion may be calculated from the number of claims or from the proportion of the number of complainants. At this time, the complaint information that is subject to the complaint proportion calculation may be narrowed by not only the applicable air-conditioned areas, but also by the season at the point in time at which the environmental parameter setting aiding procedure was performed. This is because the complaint characteristics will vary depending on the season.

Moreover, even for identical air-conditioning areas and for identical seasons, the characteristics of the claims will change as time passes, so the complaint information may be limited by the time at which the environmental parameter setting aiding process was executed or limited to recent complaint information, because there are times wherein complaint information from the past is not a useful reference. The tabulation of complaint information and the calculation of the complaint proportions may be through processing based on tabulation definition information and calculation definition information that is registered in advance in the storing portion 14.

The parameter value selecting portion 15C has a function for selecting, from the parameter values for the environmental parameters, the parameter value that is nearest to a complaint proportion of 50%, calculated by the complaint proportion calculating portion 15B. The selection of the recommended value may be through processing based on selection definition information that is registered in the storing portion 14 in advance.

The aid screen displaying portion 15D has a function for displaying, in an aid screen on a screen displaying portion 12, the complaint proportion for each parameter value, calculated by the complaint proportion calculating portion 15B, and the recommended value selected by the parameter value selecting portion 15C.

The environmental parameter setting portion 15E has a function for acquiring a determined value inputted through an operation of the aid screen, in response to an operation by the equipment operator, detected by an operation inputting portion 13, and a function for setting, as a new target value for the air-conditioning controlling system 20, through a report from the communication interface portion 11, an environmental parameter comprising the determined value that has been acquired.

### Operations in the Example

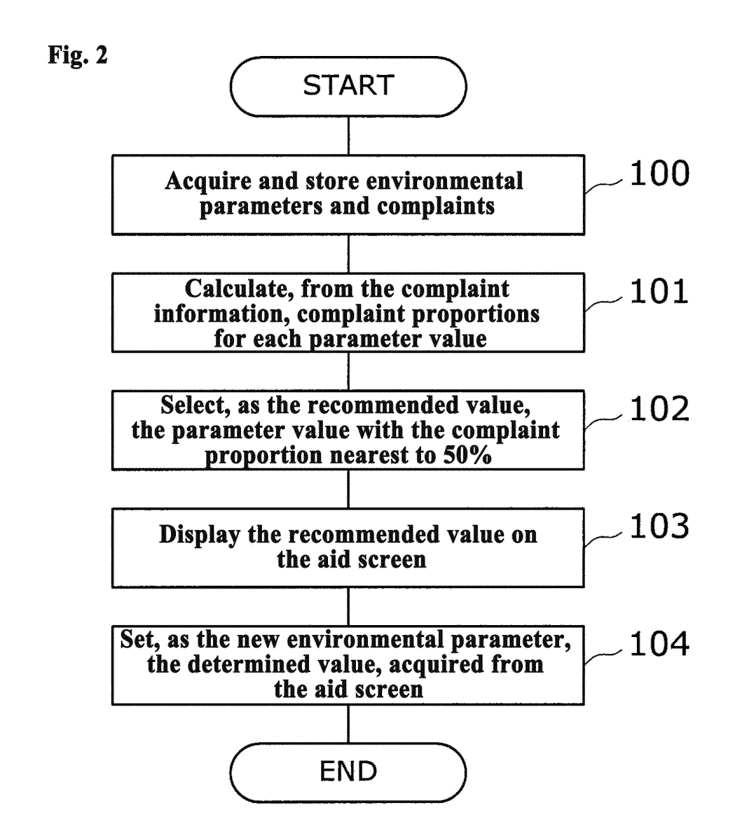

FIG. 2 will be referenced next to explain an environmental parameter setting aiding operation in an environmental parameter setting aiding device 10 according to the present example. FIG. 2 is a flowchart illustrating an environmental parameter setting aiding procedure according to the Example.

The calculation processing portion 15 executes the environmental parameter setting aiding procedure of FIG. 2 for an environmental parameter in a designated room in accordance with an operation by the equipment operator, detected by the operation inputting portion 13.

The first data acquiring portion 15A acquires the parameter values for the current environmental parameters from the air-conditioning controlling system 20 and stores them in the storing portion 14 as environmental parameter information 14A, and also acquires, from the individual occupant terminals 30 of the individual occupants, the respective complaints regarding perceptions of the temperature environments, which use the applicable parameter values, as being too hot or too cold, and stores them as complaint information in the storing portion 14 (Step 100).

Following this, the complaint proportion calculating portion 15B tabulates the complaints, for each parameter value of the environmental parameters regarding the designated room, from the complaint information 14B that is stored in the storing portion 14, and calculates ratios, for the designated room, of the perceptions of too hot/too cold, that is, calculates complaint proportions (Step 101).

At this time, the configuration may be such that the complaints indicating too hot or too cold may have only two evaluation values, namely “too hot” and “too cold, and the calculation may be for a complaint proportion regarding only one of these evaluation values. The parameter value for which the complaint proportion is calculated may be specified based on a range or interval that is set in advance. For example, if the environmental parameter is an indoor temperature setting, that the specification may use 24.0° C. through 28.0° C. as the range, and the parameter values may be set for 0.5° C. intervals, where complaint proportions may be calculated for each of these parameter values.

Following this, the parameter value selecting portion 15C may select, from the parameter values for the environmental parameter, a recommended value that is the parameter value wherein the complaint proportion, calculated by the complaint proportion calculating portion 15B, that is nearest to 50% (Step 102).

Following this, the aid screen displaying portion 15D provides the recommended value, selected by the parameter value selecting portion 15C, in an aid screen in the screen displaying portion 12 (Step 103).

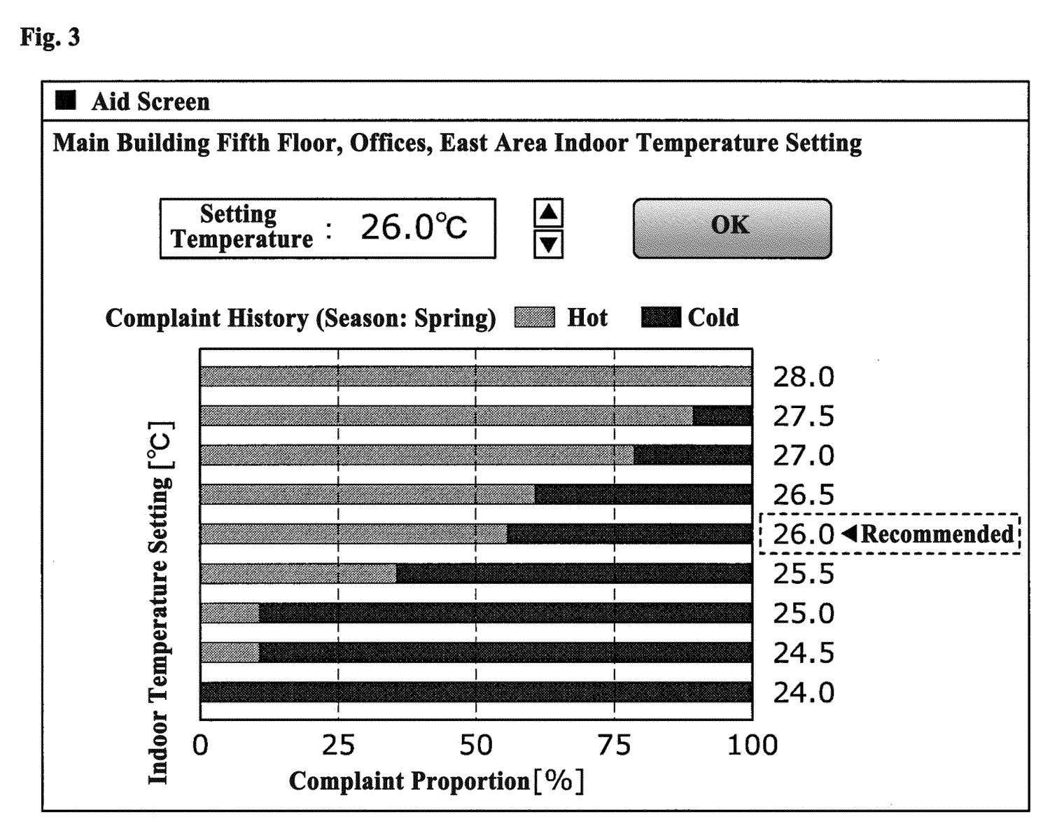

FIG. 3 is an example display for an aid screen according to the Example. Here an aid screen for the temperature within an office is displayed for the “Main Building, Fifth Floor, Offices, East Area.” A temperature setting display field that shows the details of the settings, operating buttons by which the equipment operator can adjust the temperature setting upward and downward, and an OK button for confirming the temperature setting that has been inputted are provided at the top of the aid screen. Moreover, a bar graph of the complaint proportions for the various parameter values, which are temperature settings for within the offices, is displayed at the bottom of the aid screen. Furthermore, a recommended value, selected by the parameter value selecting portion 15C, is displayed to the right of the bar graph.

Thereafter, the environmental parameter setting portion 15E acquires a value that is determined through an operating input in the aid screen in response to an operation by the equipment operator, detected by the operation inputting portion 13, where the environmental parameter that is the determined value is reported from the communication interface portion 11 to the air-conditioning controlling system 20, to be set as a new target value for the applicable air-conditioned area in the air-conditioning controlling system 20 (Step 104), thereby completing the series of environmental parameter setting aiding processes.

In this way, in the present example, the complaint proportion calculating portion 15B calculates, from the complaint information 14B that is stored in the storing portion 14, a complaint proportion that indicates the proportions of the perceptions of too hot and too cold, and the parameter value selecting portion 15C selects, from these parameter values, the value wherein the complaint proportion is nearest to 50%, as the recommended value, and the aid screen displaying portion 15D displays the recommended value in an aid screen.

As a result, this enables the equipment operator to be provided with the temperature that is the recommended value, that is, the temperature setting that will produce the best balance for the occupants as a whole, through the aid screen. Consequently, this enables aid in selecting and setting an environmental parameter value, by the equipment operator, so as to not only reduce the risk that occurs when changing a parameter value, but also enables flexible handling of complaints by occupants that they feel too cold or too hot.

In the present invention, the individual occupants may evaluate the temperature environment, through the aid screen, in terms of what complaint proportions there are for what temperatures, or may be provided with a bar graph as illustrated in, for example, FIG. 3. As a result, it is possible to provide the rationale for the selection of the recommended value to the equipment operator.

Furthermore, in the present example, the environmental parameter setting portion 15E acquires a value that is determined by an operating input in the aid screen, and sets, as a new target value for the air-conditioning controlling system 20, an environmental parameter that is the applicable determined value, enabling the equipment operator to set the new target value extremely smoothly from the aid screen wherein the recommended value is presented. At this time, the environmental parameter that is set for the air-conditioning controlling system 20 may be recorded in the storing portion 14 as history.

### Another Example

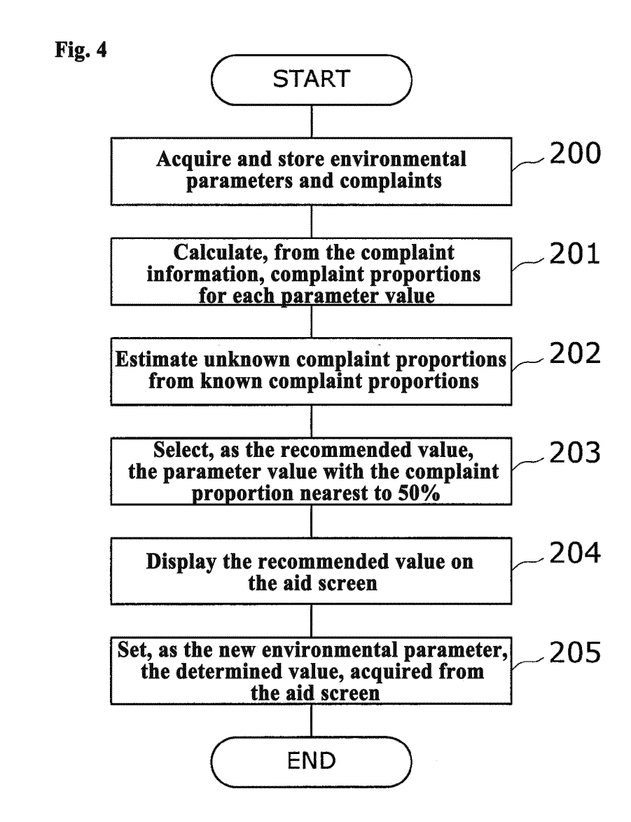

Next an environmental parameter setting aiding device 10 according to Another Example according to the present disclosure will be explained in reference to FIG. 4. FIG. 4 is a flowchart illustrating an environmental parameter setting aiding procedure according to the Another Example.

In the Example, the explanation used as an example a case wherein the complaint proportion is calculated from the complaint information 14B for each individual parameter value for the environmental parameter, but in some cases, depending on the parameter value, the number of corresponding complaints is less than a given number, so the number of complaints is insufficient for calculating the complaint proportion reliably. This is because whether or not there has been a complaint reported is left up to the occupants. In the present example, for those parameter values wherein there is insufficient complaint information in this way, the explanation will be for a case wherein estimates are based on the complaint proportions for those parameter values wherein there is complaint information.

That is, in the present example, the complaint proportion calculating portion 15B has a function for estimating a complaint proportion for a parameter value wherein the complaint information is insufficient, based on complaint proportions for those parameter values wherein there is complaint information. For this estimate of the complaint proportion, an ordinary regression calculation technique may be used to calculate a linear approximation or a non-linear approximation indicating the relationship between the parameter values and the complaint proportions based on those complaint proportions for parameter values wherein there is complaint information, and then estimating the complaint proportion, based on the linear approximation or non-linear approximation, for a parameter value wherein the complaint information is insufficient.

In the present example, the other structures are identical to those in the Example, so detailed explanations thereof are omitted.

### Operations in the Another Example

FIG. 4 will be referenced next to explain an environmental parameter setting aiding operation in an environmental parameter setting aiding device 10 according to the present example.

The calculation processing portion 15 executes the environmental parameter setting aiding procedure of FIG. 4 for an environmental parameter in a designated room in accordance with an operation by the equipment operator, detected by the operation inputting portion 13.

The first data acquiring portion 15A acquires the parameter values for the current environmental parameters from the air-conditioning controlling system 20 and stores them in the storing portion 14 as environmental parameter information 14A, and also acquires, from the individual occupant terminals 30 of the individual occupants, the respective complaints regarding perceptions of the temperature environments, which use the applicable parameter values, as being too hot or too cold, and stores them as complaint information in the storing portion 14 (Step 200).

Following this, the complaint proportion calculating portion 15B tabulates the complaints, for each parameter value of the environmental parameters regarding the designated room, from the complaint information 14B that is stored in the storing portion 14, and calculates ratios, for the designated room, of the perceptions of too hot/too cold, that is, calculates complaint proportions (Step 201).

At this time, if, among the parameter values, there is a parameter value for which the complaint information is insufficient, the complaint proportion calculating portion 15B estimates the complaint proportions for those parameter values wherein the complaint information is insufficient, based on the complaint proportions for those parameter values wherein the complaint information exists (Step 202).

Following this, the parameter value selecting portion 15C may select, from the parameter values for the environmental parameter, a recommended value that is the parameter value wherein the complaint proportion, calculated by the complaint proportion calculating portion 15B, that is nearest to 50% (Step 203).

Following this, the aid screen displaying portion 15D provides the recommended value, selected by the parameter value selecting portion 15C, in an aid screen in the screen displaying portion 12 (Step 204).

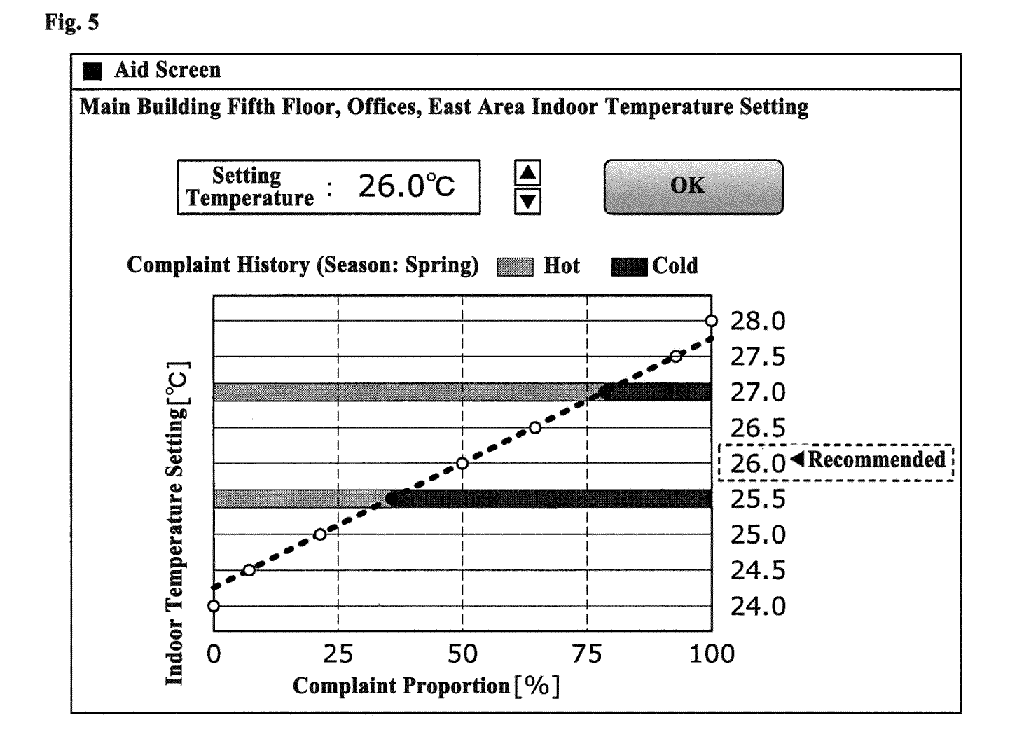

FIG. 5 is an example display for an aid screen according to the Another Example. As with FIG. 3, described above, here an aid screen for the temperature within an office is displayed for the “Main Building, Fifth Floor, Offices, East Area.” Moreover, for only those parameter values for which complaint information exists, a bar graph of the complaint proportions for the various parameter values, which are temperature settings for within the offices, is displayed at the bottom of the aid screen. Note that for the parameter values for which the complaint information is insufficient, the estimated values may be plotted as circles, and the linear approximations or non-linear approximations used in the estimates may be displayed.

Thereafter, the environmental parameter setting portion 15E acquires a value that is determined through an operating input in the aid screen in response to an operation by the equipment operator, detected by the operation inputting portion 13, where the environmental parameter that is the determined value is reported from the communication interface portion 11 to the air-conditioning controlling system 20, to be set as a new target value for the applicable air-conditioned area in the air-conditioning controlling system 20 (Step 205), thereby completing the series of environmental parameter setting aiding processes.

In this way, in the present example, if there are parameter values for which complaint information is insufficient, the complaint proportion calculating portion 15B estimates the complaint proportions for those parameter values for which the complaint information is insufficient, based on the complaint proportions for the parameter values for which there is complaint information.

As a result, even if there is insufficient complaint information, it is possible to estimate and interpolate based on existing complaint proportions, not only making it possible to reduce the risks that occur due to changes in parameter values, in the same manner as when all complaint information exists, but also enabling assistance in the equipment operator selecting and setting environmental parameter values through enabling flexible handling of complaints, regarding perceptions of being too hot or too cold, from the occupants.

### Yet Another Example

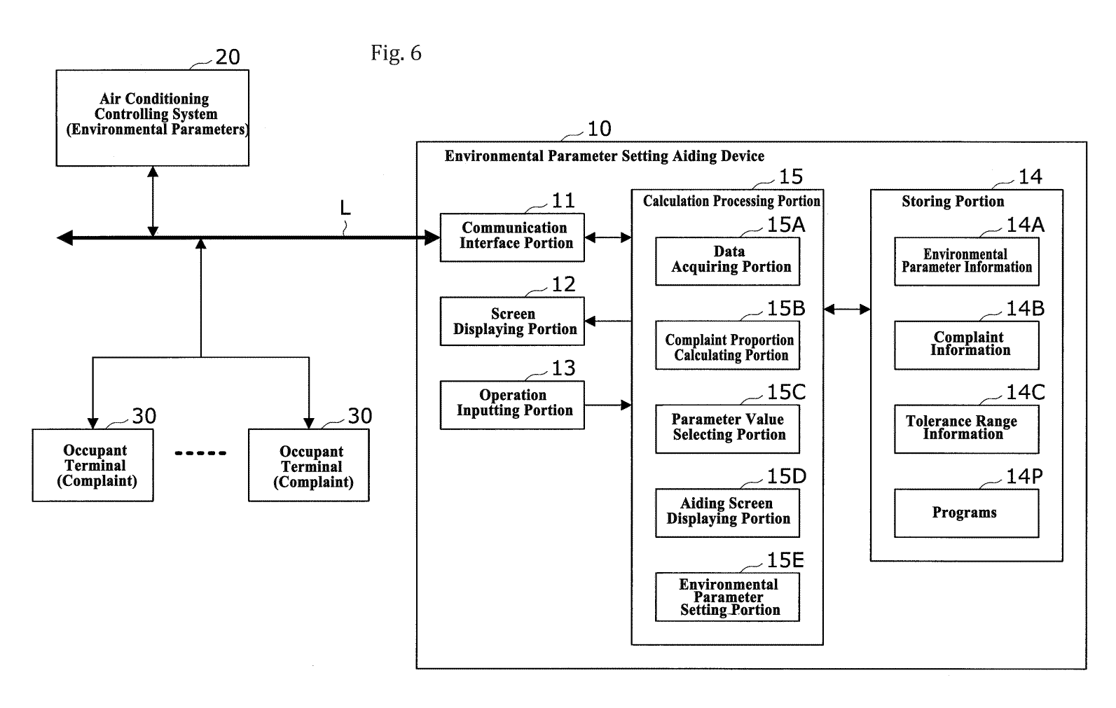

Next an environmental parameter setting aiding device 10 according to Yet Another Example according to the present disclosure will be explained in reference to FIG. 6. FIG. 6 is a block diagram illustrating a structure for an environmental parameter setting aiding device according to the Yet Another Example.

In the Example, a case wherein, in the aid screen, the parameter value wherein the complaint proportion was nearest to 50% was elected as the recommended value was explained as an example. Although this recommended value indicates a parameter value that achieves the optimal balance for the occupants over all, for equipment operators who attempting to curtail, even slightly, energy consumption, this does not always successfully select the appropriate value for the environmental parameter. A case wherein a parameter value that takes into account energy conservation, rather than just the comfort of the occupants in this way, will be explained in the present example.

In the present example, the storing portion 14 has a function for storing, in advance, as one type of process information, tolerance range information 14C indicating the range of complaint proportions, from among the parameter values that can be assumed by the environmental parameters, that are tolerable for the various residents. Although the optimal balance for complaints indicating perceptions of being too hot or too cold, in relation to the temperature environment, is the case wherein the complaint proportion is at 50%, a tolerance range is set in advance by the equipment operator as that which specifies the range that can be tolerated for the temperature environment by the various occupants even if, from the perspective of energy conservation, this deviates from the state wherein this balance is optimized.

The parameter value selecting portion 15C has a function for selecting, from among the parameter values, a “comfort value,” which is the parameter value that has the complaint proportion that is nearest to 50%, and a function for selecting, from among parameter values wherein the complaint proportion is within the tolerance range that has been set in advance, an “energy-saving value,” which is the parameter value that saves the most energy. At this time, during air-conditioning operations, the highest temperature setting within the tolerance range is selected as the energy-saving value, and during heating operations, the lowest temperature setting within the tolerance range is selected as the energy-saving value.

The aid screen displaying portion 15D has a function for displaying the comfort value and the energy-saving value on the aid screen.

In the present example, the other structures are identical to those in the Example, so detailed explanations thereof are omitted.

### Operations in the Yet Another Example

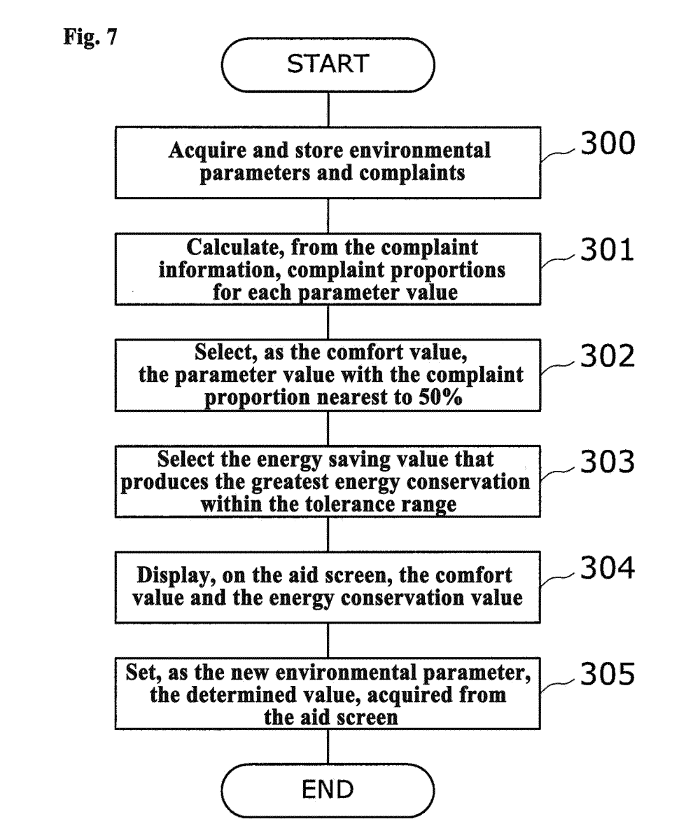

FIG. 7 will be referenced next to explain an environmental parameter setting aiding operation in an environmental parameter setting aiding device 10 according to the present example. FIG. 7 is a flowchart illustrating an environmental parameter setting aiding procedure according to the Yet Another Example.

The calculation processing portion 15 executes the environmental parameter setting aiding procedure of FIG. 7 for an environmental parameter in a designated room in accordance with an operation by the equipment operator, detected by the operation inputting portion 13.

The first data acquiring portion 15A acquires the parameter values for the current environmental parameters from the air-conditioning controlling system 20 and stores them in the storing portion 14 as environmental parameter information 14A, and also acquires, from the individual occupant terminals 30 of the individual occupants, the respective complaints regarding perceptions of the temperature environments, which use the applicable parameter values, as being too hot or too cold, and stores them as complaint information in the storing portion 14 (Step 300).

Following this, the complaint proportion calculating portion 15B tabulates the complaints, for each parameter value of the environmental parameters regarding the designated room, from the complaint information 14B that is stored in the storing portion 14, and calculates ratios, for the designated room, of the perceptions of too hot/too cold, that is, calculates complaint proportions (Step 301).

Following this, The parameter value selecting portion 15C selects, from among the environmental parameter values, a “comfort value,” which is the parameter value that has the complaint proportion that is nearest to 50% (Step 302), and selects, from among parameter values wherein the complaint proportion is within the tolerance range that has been set in advance, an “energy-saving value,” which is the parameter value that saves the most energy (Step 303).

Following this, the aid screen displaying portion 15D provides the comfort value and the energy-saving value, selected by the parameter value selecting portion 15C, in an aid screen in the screen displaying portion 12 (Step 304).

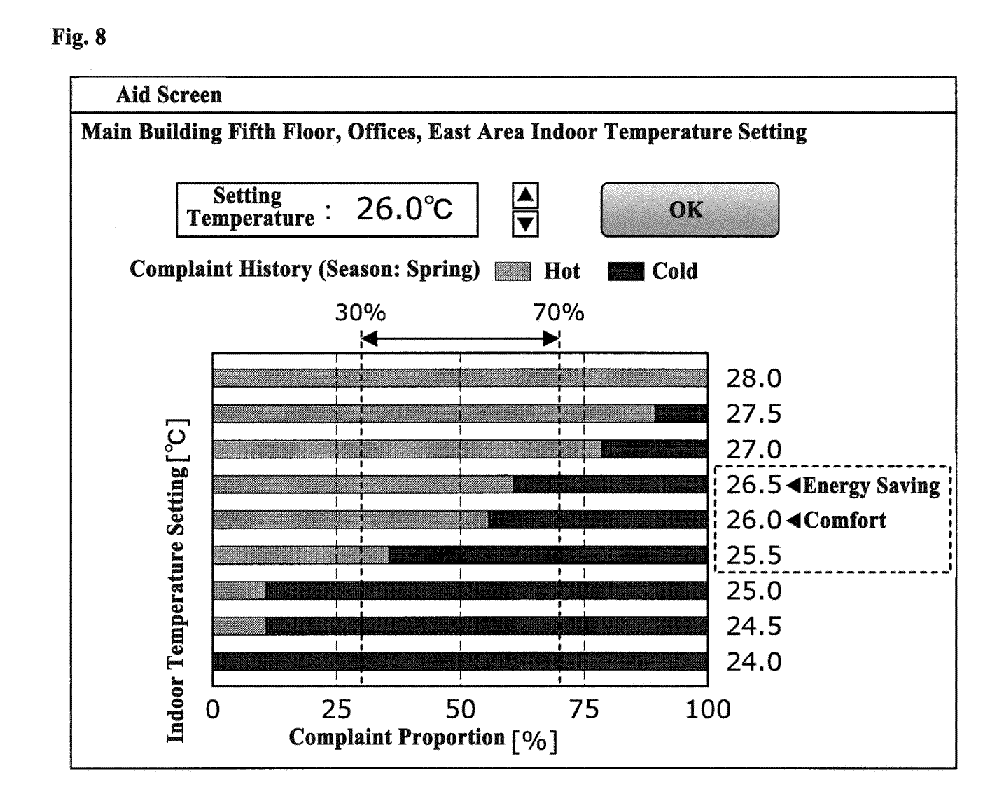

FIG. 8 is an example display for an aid screen according to the Yet Another Example. As with FIG. 3, described above, here an aid screen for the temperature within an office is displayed for the “Main Building, Fifth Floor, Offices, East Area.” A bar graph of the complaint proportions for the various parameter values, which are temperature settings for within the offices, is displayed at the bottom of the aid screen. Furthermore, a comfort value and an energy-saving value, selected by the parameter value selecting portion 15C, is displayed to the right of the bar graph.

Thereafter, the environmental parameter setting portion 15E acquires a value that is determined through an operating input in the aid screen in response to an operation by the equipment operator, detected by the operation inputting portion 13, where the environmental parameter that is the determined value is reported from the communication interface portion 11 to the air-conditioning controlling system 20, to be set as a new target value for the applicable air-conditioned area in the air-conditioning controlling system 20 (Step 305), thereby completing the series of environmental parameter setting aiding processes.

In this way, in the present example, the parameter value selecting portion 15C has selects, from among the parameter values, a “comfort value,” which is the parameter value that has the complaint proportion that is nearest to 50%, and selects, from among parameter values wherein the complaint proportion is within the tolerance range that has been set in advance, an “energy-saving value,” which is the parameter value that saves the most energy, and the aid screen displaying portion 15D displays the comfort value and the energy savings value on an aid screen.

This makes it possible to provide, to the equipment operator, not only a comfort value that indicates a parameter value that strikes the best balance for the occupants as a whole, but also an energy savings value that takes into account energy conservation, within the tolerance range of the various occupants for the temperature environment. Consequently, this enables the equipment operator to select an appropriate environmental parameter value based on the comfort value and the energy savings value, thereby making it possible to provide aid that takes the intentions of the equipment operator, rather than just the occupants, into account when the equipment operator selects and sets environmental parameter values.

### Extended Examples

While the present disclosure was explained above in reference to examples, the present disclosure is not limited by the examples set forth above. The structures and details of the present disclosure may be modified in a variety of ways, as can be understood by those skilled in the art, within the scope of the present disclosure. Moreover, the present disclosure may be embodied through combining the various examples, insofar as there are no contradictions.

1. An environmental parameter setting aiding device for aiding a setting of an environmental parameter that is a target value for an air-conditioning controlling system, based on a complaint from an occupant, the environmental parameter setting aiding device comprising:
a data acquiring system that acquires, and saves as environmental parameter information, a current parameter value of an environmental parameter of the air conditioning controlling system, and acquires, and saves as complaint information, complaints from various occupants indicating perceptions that a temperature environment, using the parameter value, is too hot or too cold;
a complaint proportion calculating portion that calculates, from the complaint information that has been stored, a complaint proportion, indicating a proportion of perceptions of being too hot or too cold, for each individual parameter value;
a parameter value selecting portion that selects, as a recommended parameter value, the parameter value wherein the complaint proportion is nearest to 50%; and
an aid screen displaying portion that presents the recommended value in an aid screen.

2. The environmental parameter setting aiding device as set forth in claim 1, wherein:
the complaint proportion calculating portion estimates a complaint proportion for a parameter value wherein there is insufficient complaint information, based on a complaint proportion for a parameter value wherein there is complaint information for the parameter value.

3. The environmental parameter setting aiding device as set forth in claim 1, wherein:
the parameter value selecting portion selects, from among the parameter values, a “comfort value,” which is the parameter value that has the complaint proportion that is nearest to 50%, and selects, from among parameter values wherein the complaint proportion is within the tolerance range that has been set in advance, an “energy-saving value,” which is the parameter value that saves the most energy; and
the aid screen displaying portion provides, in the aid screen, the comfort value and the energy-saving value.

4. The environmental value setting aiding device as set forth in claim 1,
further comprising:
an environmental parameter setting portion that acquires a value that is determined by an operating input by the aid screen, and sets, as a new target value for the air-conditioning controlling system, an environmental parameter that is the determined value.

5. An environmental parameter setting aiding method used in an environmental parameter setting aiding device for aiding the setting of an environmental parameter that is a target value for an air-conditioning controlling system, based on a complaint from an occupant, the method comprising:
a data acquiring step wherein a data acquiring system acquires, and saves as environmental parameter information, a current parameter value of an environmental parameter of the air conditioning controlling system, and acquires, and saves as complaint information, complaints from various occupants indicating perceptions that the temperature environment, using the parameter value, is too hot or too cold;
a complaint proportion calculating step wherein a complaint proportion calculating portion calculates, from the complaint information that has been stored, a complaint proportion, indicating the proportion of perceptions of being too hot or too cold, for each individual parameter value;
a parameter value selecting step wherein a parameter value selecting portion selects, as a recommended parameter value, the parameter value wherein the complaint proportion is nearest to 50%; and
an aid screen displaying step wherein an aid screen displaying portion presents the recommended value in an aid screen.
